(19) United States
(12) Patent Application Publication
(10) Pub. No.: US 2010/0296733 A1
(43) Pub. Date: Nov. 25, 2010

(54) APPARATUS AND METHOD FOR STORING HAND WRITING IN A COMPUTING DEVICE SUPPORTING ANALOG INPUT

(75) Inventor: Jae-Young YANG, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/765,100

(22) Filed: Apr. 22, 2010

(30) Foreign Application Priority Data
May 19, 2009 (KR) 10-2009-0043409

(51) Int. Cl. G06K 9/18

(52) U.S. Cl. 382/186

(57) ABSTRACT

Provided is a handwriting storage method in a computing device capable of analog input. The handwriting storage method receives handwriting through an analog input unit, decomposes the handwriting into at least one vector, and stores the at least one vector as a straight-type character.

### CLAIM OF PRIORITY

This application claims the benefit of the earlier filing date, under 35 U.S.C. §119, to that patent application entitled “Apparatus and Method for Storing Hand Writing in a Computing Device Supporting Analog Input,” filed in the Korean Intellectual Property Office on May 19, 2009 and afforded serial 10-2009-0043409, the contents of which are incorporated herein by reference in its entirety.

### BACKGROUND OF THE INVENTION

1. Field of the Invention

The present invention relates to the field of computing devices. More particularly, the present invention relates to an apparatus and method for storing handwriting in a computing device capable of analog input.

2. Description of the Related Art

Computing devices, such as computers and portable terminals, include an input means for recognizing a user's input. As the input means, for example, there are the keyboard and mouse of the computer and the keypad of the portable terminal. Herein, the keyboard and the keypad are a digital input means that may receive only a predetermined value, and the mouse is an analog input means having a higher degree of freedom than the digital input means. However, the mouse is inappropriate for delicate analog input capable of handwriting. Accordingly, as technology advances, an input means capable of a more delicate analog input is being applied for users' convenience. For example, a touch screen and a tablet are becoming more popular as devices. Consequently, by inputting handwriting to a computer or a portable terminal, a user can more easily input characters than by inputting the characters using keys located on a keypad or a keyboard.

Generally, input handwriting is stored in an image format such as JPEG and BMP, or a character code such as Unicode and ASCII code. However, when the input handwriting is stored as a character code, the recognition rate of handwriting is low. However, when the input handwriting is stored as a character code, a storage capacity is large and it is difficult to edit images. That is, since the recognition rate of handwriting is low, a character that is not desired by a user may be stored. Moreover, since a storage capacity is large, a traffic volume increases when handwriting is transmitted over a communication network. Accordingly, a method that may efficiently store handwriting inputted through an analog input means is required.

### SUMMARY OF THE INVENTION

Accordingly, an object of the present invention is to provide an apparatus and method for storing handwriting in a computing device capable of analog input.

Another object of the present invention is to provide a handwriting storage apparatus and method, which store handwriting with vectors composing the handwriting in a computing device capable of analog input.

Another object of the present invention is to provide a handwriting storage apparatus and method, which store handwriting with the change amount of edge coordinates composing the handwriting in a computing device capable of analog input.

Another object of the present invention is to provide a handwriting storage apparatus and method, which determine a circle-type character from among characters composing the handwriting in a computing device capable of analog input.

According to an aspect of the present invention, a handwriting storage method in a computing device capable of analog input includes: receiving handwriting through an analog input unit; decomposing the handwriting into at least one vector; and storing the at least one vector as a straight-type character.

According to another aspect of the present invention, a computing device capable of analog input includes: an analog input unit receiving handwriting; and a controller decomposing the handwriting into at least one vector, storing the at least one vector and determining a character shape based on characteristics of the at least one vector.

Accordingly to another aspect of the invention, an apparatus for processing handwriting input on a portable device comprising: a processor in communication with a memory, the memory including code which when accessed by the processor causes the processor to receive at least one vector from an analog input associated with the portable device; determine a perpendicular line to each of the at least one vectors; and store at least one of a vector and a vector change amount with respect to a coordinate of a preceding vector.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates an analysis result for storing handwriting of the character [symbol] according to an embodiment of the present invention;

FIG. 2 (shown as FIGS. 2A and 2B) illustrate a handwriting storage format according to an embodiment of the present invention;

FIG. 3 illustrates an extraction result of the contour line of a blob which is included in handwriting according to an embodiment of the present invention;

FIG. 4 is a flow chart illustrating an operation of storing handwriting in a computing device according to an embodiment of the present invention;

FIG. 5 is a flow chart illustrating an operation of storing handwriting in a computing device according to another embodiment of the present invention; and

FIG. 6 is a block diagram illustrating a computing device according to an embodiment of the present invention.

### DETAILED DESCRIPTION OF THE INVENTION

The following description, with reference to the accompanying drawings, is provided to assist a person of ordinary skill in the art with an understanding of exemplary embodiments of the present invention as defined by the claims. The description includes various specific details to assist in that understanding but these details are to be regarded as merely exemplary. Accordingly, those of ordinary skill in the art will recognize that various changes and modifications of the exemplary embodiments described herein can be made without departing from the scope and spirit of the invention as defined by the appended claims. Also, descriptions of well-known functions and constructions may be omitted for conciseness so as not to obscure appreciation of the present invention by a person of ordinary skill with such well-known functions and constructions.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims.

It is to be understood that the singular forms “a”, “an”, and “the” include plural references unless the context clearly dictates otherwise. Thus, for example, reference to “a component surface” typically includes reference to one or more of such surfaces.

The term “substantially” typically means that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Preferred embodiments of the present invention will be described below with reference to the accompanying drawings.

The following description will be made on a technology for storing handwriting in a computing device capable of analog input. In the following description, the computing device may include a cellular phone, a personal portable communication phone, a complex wireless terminal, an IMT 2000 terminal, a laptop computer and a desktop computer.

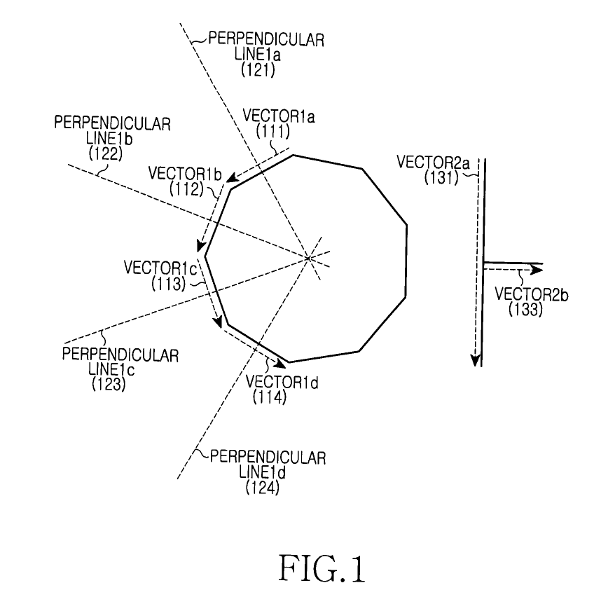

FIG. 1 is a diagram illustrating a result of an analysis for storing handwriting character [symbol] according to an embodiment of the present invention. Referring to FIG. 1, handwriting is decomposed into a plurality of vectors. Since handwriting inputted to a computing device is composed of a plurality of pixels, it has a straight type as partially seen and therefore may be expressed as a plurality of vectors. In FIG. 1, for convenience, although the character [symbol] is rather exaggerated and is thereby expressed as a small number of straight lines, actually-inputted handwriting and the number of straight lines are merely different, and it is apparent that actually-inputted handwriting may also be decomposed into straight lines.

To first provide a description on the case of the character [symbol] , the computing device decomposes [symbol] into vector units from a specific start point. At the start point of the decomposition, the computing device cannot know whether a character that is being decomposed is the character [symbol] . Accordingly, the computing device calculates a perpendicular line of the vector each time one vector is completed. Therefore, the computing device completes a ‘vector 1a’ 111 and calculates a ‘perpendicular line 1a’ 121. Subsequently, the computing device completes a ‘vector 1b’ 112, a ‘vector 1c’ 113 and a ‘vector 1d’ 114 and simultaneously calculates a corresponding ‘perpendicular line 1b’ 122, a ‘perpendicular line 1c’ 123 and a ‘perpendicular line 1d’ 124. At this point, the computing device recognizes that the perpendicular lines 121 to 124 are crossed in the same direction. Thus, the computing device recognizes that a character which is being analyzed is the character [symbol] , and terminates the decomposition of the vector. That is, when a critical, or more, number of vectors are completed and the perpendicular lines of the respective vectors are crossed in the same direction, the computing device recognizes that the character that is being analyzed is [symbol] . Depending on the case, since the character [symbol] is composed of a very large number of vectors, it is not stored as a vector and is stored as the change amount of the end-point coordinates of each vector, i.e., the change amount of edge coordinates. In other words, the character [symbol] is stored as a delta modulation function corresponding to the coordinates of the edge points of a line. For example, in FIG. 1, when the start point of the ‘vector 1a’ 111 is (0, 0), the end point of the ‘vector 1a’ 111 is (−3, −1), the end point of the ‘vector 1b’ 112 is (−6, −4), the end point of the ‘vector 1c’ 113 is (−6, −7) and the end point of the ‘vector 1d’ 114 is (−4, −10), the storage data of the character [symbol] is “(0, 0)(−3, −1)(−3, −3)(0, −3)(+2, −3)”.

To next provide a description on the case of the character [symbol] , since the character [symbol] is composed of two vectors such as a ‘vector 2a’ 131 and a ‘vector 2b’ 132, a critical, or more, number of vectors for recognizing the character [symbol] is not completed. Accordingly, the character [symbol] is stored as individual vectors. At this point, three or more vectors may be completed according to a user's handwriting. Therefore, the critical number of vectors for recognizing the character [symbol] may be set as an appropriate value according to a statistic and an experiment.

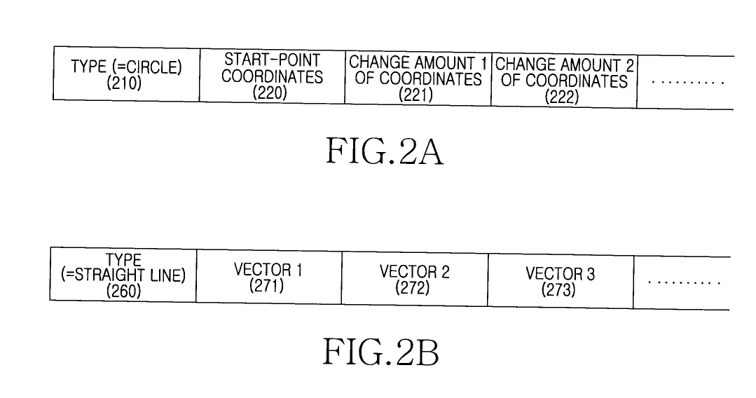

As described above with reference to FIG. 1, handwriting is stored as vectors or start coordinates and change amount of coordinates. In other words, the character [symbol] is stored as start coordinates and change amount of coordinates. Similarly, the character [symbol] is stored as start coordinates, change amount of coordinates and vectors, and other vowels and consonants are stored as vectors. At this point, the storage format of handwriting is as illustrated in FIGS. 2A and 2B. As illustrated in FIGS. 2A and 2B, the storage format is composed of type and storage data. Referring to FIG. 2A, in the case of a circle-type character such as the character [symbol] , a handwriting storage data includes a type 210 that is set as a value representing the character [symbol] , a start-point coordinate 220 indicating the first point, a coordinate ‘1’ 221 representing the change amount from the first point to the second point, and a coordinate ‘2’ 222 representing the change amount from the second point to the third point. Referring to FIG. 2B, in the case of a straight-type character such as the character [symbol] , a handwriting storage data includes a type 260 that is set as a value representing a straight line, a vector ‘1’ 271 representing a first vector that composes the character, a vector ‘2’ 272 representing a second vector, and a vector ‘3’ 273 representing a third vector.

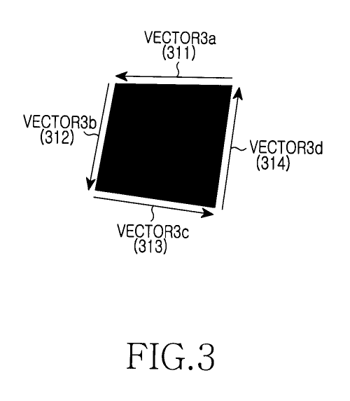

Handwriting may include a pixel blob as illustrated in FIG. 3, in addition to a circle-type character such as the character [symbol] , and a straight-type character such as the character [symbol] . As illustrated in FIG. 3, the blob is not composed of lines like the circle-type character and the straight-type character, and it is composed of pixels that fill the region of a specific range. Accordingly, the figure of the blob is stored as a contour line. At this point, the figure of the blob is stored as vectors or start coordinates and change amount of coordinates according to the shape of a contour line, and type information representing a blob.

As described above, the handwriting storage device according to an embodiment of the present invention stores handwriting as a circle, a straight line and a blob. According to embodiments of the present invention, as described above, the computing device stores handwriting at the same time with the input of a user's handwriting or it stores handwriting after the input of the user's handwriting is completed.

The operation and configuration of the above-described computing device for storing handwriting will be described in detail with reference to the accompanying drawings.

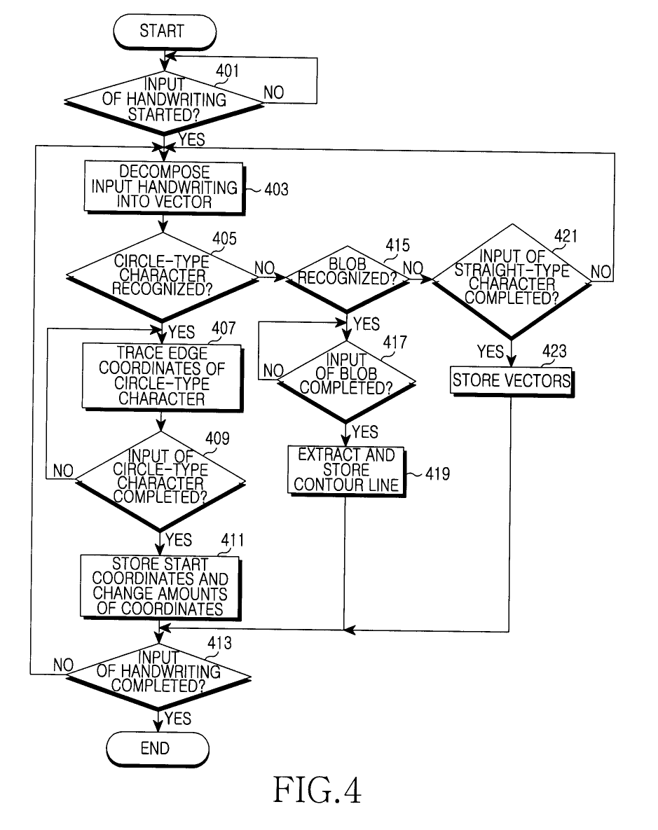

FIG. 4 is a flow chart illustrating an operation of storing handwriting in a computing device in which the computing device stores handwriting at the same time with the input of the handwriting according to an embodiment of the present invention.

Referring to FIG. 4, the computing device checks whether to start the input of handwriting in step 401. In other words, the computing device checks whether a handwriting input application is executed according to a user's manipulation and handwriting is inputted through an analog input means.

When the input of handwriting is started, the computing device proceeds to step 403 and decomposes the input handwriting into vectors. That is, when pixels are generated according to the input of handwriting, the computing device checks the advancing direction of the pixels, and composes a vector with pixels that are disposed on the same straight line. At this point, the computing device calculates the normal vectors of the composed vector and checks the cross points of the normal vectors.

Subsequently, the computing device proceeds to step 405 and checks whether a circle-type character is recognized. At this point, the computing device determines whether a character is a circle-type character using the number of continuous vectors and the locations of the cross points of the perpendicular lines. For example, the computing device checks whether at least a critical number of vectors are continuously connected and all the perpendicular lines of respective vectors are crossed in the same direction.

When the circle-type character is recognized, the computing device proceeds to step 407 and traces the edge coordinates of the circle-type character. In other words, the computing device composes pixels, which are generated according to the input of the user's handwriting, into vectors and records the coordinates of the end points of each vector.

The computing device proceeds to step 409 and checks whether the input of the circle-type character is completed. In one aspect of the invention, the computing device checks whether a vector that is not connected to the circle-type character is inputted. When the input of the circle-type character is not completed, the computing device returns to step 407.

On the other hand, when the input of the circle-type character is completed, the computing device proceeds to step 411 and stores start coordinates and the change amount of coordinates as the circle-type character. In other words, the computing device calculates each edge coordinate and a change amount with respect to preceding coordinates. The computing device generates a handwriting data that includes type information representing a circle-type character, start coordinates and the change amounts of coordinates.

Subsequently, the computing device proceeds to step 413 and checks whether the input of handwriting is completed. For example, the computing device checks whether an application for the input of handwriting is ended or the input completion of handwriting is indicated through the user's manipulation.

When the circle-type character is not recognized in step 405, the computing device proceeds to step 415 and checks whether a blob is recognized. For example, the computing device checks whether a critical or more number of pixels are dense. To this end, the computing device determines a density of pixels around where pixels is generated, and determines whether the density is higher that a threshold.

When the blob is inputted, the computing device proceeds to step 417 and checks whether the input of the blob is completed. That is, the computing device checks whether a new input is generated in a location that is separated from the blob.

When the input of the blob is completed, the computing device proceeds to step 419, extracts the contour line of the blob and stores the blob by using the contour line. At this point, when the contour line composes a circle-type character, the computing device stores start coordinates and the change amounts of coordinates as the contour line, and when the contour line composes a straight-type character, the computing device stores vectors as the contour line. That is, the computing device generates a handwriting data that includes contour line information and field information representing a blob. The computing device proceeds to step 413.

When the blob is not recognized in step 415, the computing device checks whether the input of a straight-type character is completed. When input handwriting is not recognized as a circle-type character or a blob, the computing device recognizes the input handwriting as a straight-type character and checks whether the input of the straight-type character is completed. That is, the computing device checks whether a vector that is not connected to a preceding input vector is inputted. When the input of the straight-type character is not completed, the computing device returns to step 403.

On the other hand, when the input of the straight-type character is completed, the computing device proceeds to step 423 and stores vectors as the straight-type character. That is, the computing device generates a handwriting data that composes type information representing a straight-type character and vector information composing the straight-type character.

Subsequently, the computing device proceeds to step 413 and checks whether the input of handwriting is completed. When the input of handwriting is not completed, the computing device proceeds to step 403, and when the input of handwriting is completed, the computing device ends a corresponding operation.

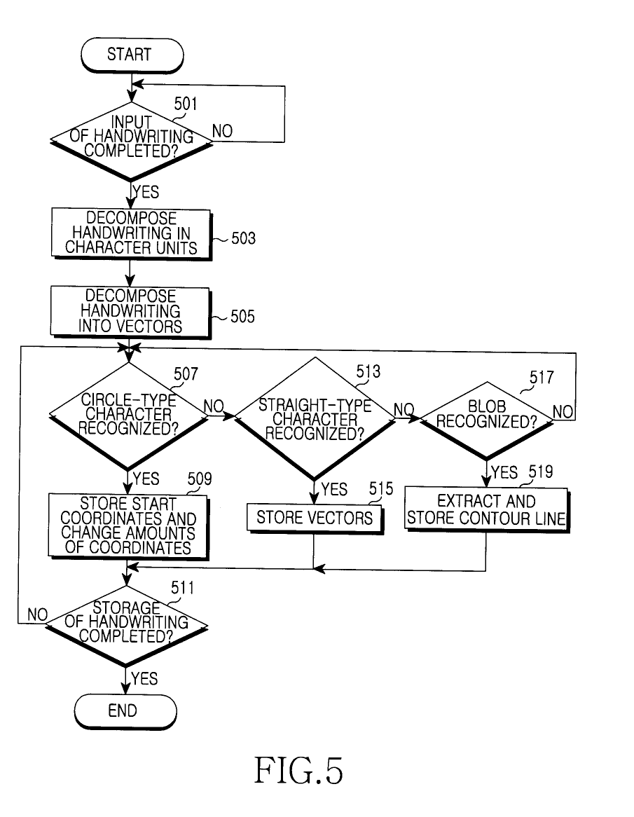

FIG. 5 is a flow chart illustrating an operation of storing handwriting in a computing device according to another embodiment of the present invention. FIG. 5 illustrates an operation of a case in which the computing device stores handwriting after the input of the handwriting is completed.

Referring to FIG. 5, the computing device checks whether the input of handwriting is completed in step 501. For example, the computing device checks whether the handwriting input is ended, the input completion of handwriting is indicated through the user's manipulation or the storage of handwriting is indicated through the user's manipulation.

When the handwriting input is completed, the computing device proceeds to step 503 and decomposes the input handwriting into character units. At this point, the each character is decomposed according to whether an input point is rapidly moved, or it is decomposed by providing input regions that are segmented by a character when inputting handwriting.

Subsequently, the computing device proceeds to step 505 and decomposes a character into vectors. That is, the computing device searches a pixel in a predetermined direction. When the pixel is searched, the computing device composes a vector with pixels that are disposed on the same straight line and are connected to the searched pixel. Moreover, the computing device calculates the normal vectors of the composed vectors and checks the cross points of the normal vectors, as previously discussed.

After the character is decomposed into vectors, the computing device proceeds to step 507 and checks whether a circle-type character is recognized. At this point, the computing device determines whether a character is a circle-type character using the number of continuous vectors and the locations of the cross points of perpendicular lines. For example, the computing device checks whether at least a critical number of vectors are continuously connected and the perpendicular lines of respective vectors are crossed in the same direction.

When the circle-type character is recognized, the computing device proceeds to step 509 and stores start coordinates and the change amount of coordinates as the circle-type character. In other words, the computing device calculates each edge coordinate and a change amount with respect to preceding coordinates. The computing device generates a handwriting data that includes type information representing a circle-type character, start coordinates and the change amounts of coordinates.

Subsequently, the computing device proceeds to step 511 and checks whether the storage of the character is completed. That is, the computing device checks whether all handwriting that composes characters are stored. When the storage of handwriting characters is completed, the computing device terminates a corresponding operation, and when the storage of handwriting characters is not completed, the computing device returns to step 507.

When the circle-type character is not recognized in step 507, the computing device proceeds to step 513 and checks whether a straight-type character is recognized. That is, the computing device checks whether a character that is composed of a number of vectors less than a critical number.

When the straight-type character is recognized, the computing device proceeds to step 515 and stores vectors as the straight-type character. That is, the computing device generates a handwriting data that includes type information representing a straight-type character and vector information composing the straight-type character. Subsequently, the computing device proceeds to step 511.

When the straight-type character is not recognized in step 513, the computing device proceeds to step 517 and checks whether a blob is recognized. For example, the computing device checks whether at least a critical number of pixels is dense.

When the blob is recognized, the computing device proceeds to step 519, extracts the contour line of the blob and stores the blob with the contour line. At this point, when the contour line composes a circle-type character, the computing device stores start coordinates and the change amounts of coordinates as the contour line, and when the contour line composes a straight-type character, the computing device stores vectors as the contour line. That is, the computing device generates a handwriting data that includes field information representing a blob and contour line information.

Subsequently, the computing device proceeds to step 511 and checks whether the storage of handwriting is completed. When the storage of handwriting is completed, the computing device returns to step 505, and when the storage of handwriting is not completed, the computing device terminates a corresponding operation.

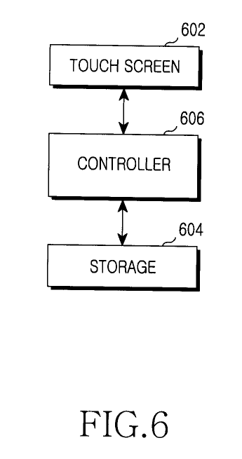

FIG. 6 is a block diagram illustrating a computing device according to an embodiment of the present invention.

Referring to FIG. 6, a computing device according to an embodiment of the present invention includes a touch screen 602, a storage 604, and a controller 606.

The touch screen 602 performs a display function of displaying visual information and an input function of recognizing an analog input. That is, the touch screen 602 displays figures, characters, images, pictures and the state of the computing device in a visual format visible to a user, according to the control of the controller 606. The touch screen 602 provides information, including the generation location, pressure level and pressure range of a touch input by the user, to controller 606. For example, the touch screen 602 includes any one of Cathode Ray Tube (CRT), Liquid Crystal Display (LCD) and Organic Light Emitting Display (OLED), for the display function. Moreover, the touch screen 602 includes a touch panel, for the input function.

The storage 604 stores micro codes, applications, content data and temporary data necessary for the operation of the computing device. Particularly, the storage 604 stores a handwriting data that is generated by the controller 606. Herein, the handwriting data is divided into type information representing the kind of a character and character information. In the case of a circle-type character, the character information includes start coordinates and the change amount of coordinates. In the case of a straight-type character, the character information includes a vector. In the case of a blob, the character information includes a contour line.

The controller 606 controls the overall operation of the computing device. For example, the controller 606 provides a picture data to the touch screen 602, and performs a function corresponding to an input data that is inputted through the touch screen 602. Moreover, the controller 606 performs the applications that are stored in the storage 604. Particularly, the controller 606 stores handwriting, which is inputted through the touch screen 602, in the storage 604. For storing the handwriting, the controller 606 checks the kinds of characters composing the handwriting. That is, the controller 606 determines a circle-type character, a straight-type character and a blob (as shown in FIGS. 4 and 5), and generates a handwriting data having a format corresponding to each kind. At this point, according to embodiments of the present invention, the controller 606 stores handwriting at the same time with the input of the handwriting, or when the input of handwriting is completed, the controller 606 stores the handwriting.

In the case of the circle-type character, the controller 606 determines whether a character is a circle-type character by using the number of continuous vectors and the locations of the cross points of perpendicular lines. For example, when at least a critical number of vectors are continuously connected and all the perpendicular lines of respective vectors are crossed in the same direction, the controller 606 determines the character as the circle-type character. Accordingly, the controller 606 checks the edge coordinates of the circle-type character, and stores the start coordinates and change amounts of the edge coordinates as the circle-type character. In other words, the controller 606 calculates each edge coordinate and a change amount with respect to preceding coordinates. The controller 606 generates a handwriting data that includes type information representing the circle-type character, start coordinates and the change amounts of coordinates.

In the case of the blob, the controller 606 determines whether a character is a blob according to the density of pixels. For example, when a critical or more number of pixels is dense around one pixel, the controller 606 determines the character as being the blob. Accordingly, the controller 606 extracts the contour line of the blob, and generates a handwriting data that includes field information representing the blob and contour line information. At this point, when the contour line composes a circle-type character, the controller 606 stores start coordinates and the change amounts of coordinates as the contour line, and when the contour line composes a straight-type character, the controller 606 stores vectors as the contour line.

In the case of the straight-type character, the controller 606 determines a character, which is not the circle-type character and the blob, as a straight-type character. Accordingly, the controller 606 decomposes the straight-type character into vectors, and generates a handwriting data that includes type information representing a straight-type character and vectors.

As illustrated in FIG. 6, the computing device includes the touch screen 602 for an analog input. According to another embodiment of the present invention, however, the computing device may include another type of analog input means.

Moreover, if the computing device is a communication device such as a portable phone, a smart phone and a Personal Digital Assistants (PDA), the computing device may further include a communication unit for providing a wireless interface (not shown). The communication unit changes an information bit stream, which is provided from the controller 606, into a Radio Frequency (RF) signal according to a communication protocol and transmits the RF signal through an antenna. The communication unit changes an RF signal, which is received through the antenna, into an information bit stream according to the communication protocol and provides the bit stream to the controller 606.

The computing device capable of analog input decomposes handwriting into vectors and stores the handwriting with a vector, the change amount of coordinates or a contour line according to a character type, thereby minimizing the storage capacity of handwriting.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer is loaded with, or accesses, code that may be stored in a memory component, the general purpose computer is transformed into a special purpose computer suitable for at least executing and implementing the processing shown herein.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method for storing a handwriting in a computing device capable of analog input, the method comprising:
receiving handwriting through an analog input unit;
decomposing the handwriting into at least one vector; and
storing the at least one vector as a straight-type character.

2. The method of claim 1, further comprising:
checking edge coordinates of a circlet-type character, when the circle-type character is recognized; and
storing start coordinates and change amounts of the edge coordinates as the circle-type character.

3. The method of claim 2, further comprising:
calculating at least one perpendicular line corresponding to the at least one vector; and
determining whether a character is the circle-type character by using the at least one vector and the corresponding at least one perpendicular line.

4. The method of claim 3, wherein determining whether a character is the circle-type character comprises:
determining the character as being the circle-type character when a critical or more number of vectors are continuously connected and all perpendicular lines of respective vectors are crossed in the same direction.

5. The method of claim 1, further comprising:
storing start coordinates representing a contour line and change amounts of edge coordinates or vectors as a blob, when the blob is recognized.

6. A computing apparatus capable of analog input, the apparatus comprising:
an analog input unit receiving handwriting; and
a controller:
decomposing the handwriting into at least one vector,
determining a character shape based on characteristics of the at least one vector; and
storing the at least one vector.

7. The apparatus of claim 6, wherein the controller, when a circle-type character is recognized, checks edge coordinates of the circlet-type character, and stores start coordinates and change amounts of the edge coordinates as the circle-type character.

8. The apparatus of claim 7, wherein the controller calculates at least one perpendicular line corresponding to the at least one vector, and determines whether a character is the circle-type character by using the at least one vector and the corresponding at least one perpendicular line.

9. The apparatus of claim 8, wherein the controller determines the character as being the circle-type character when a critical or more number of vectors are continuously connected and all perpendicular lines of respective vectors are crossed in the same direction.

10. The apparatus of claim 6, wherein the controller stores start coordinates representing a contour line and change amounts of edge coordinates or vectors as a blob when the blob is recognized.

11. An apparatus for processing handwriting input on a portable device comprising:
a processor in communication with a memory, the memory including code which when accessed by the processor causes the processor to:
receive at least one vector from an analog input associated with the portable device;
determine a perpendicular line to each of the at least one vectors; and
store at least one of a vector and a vector change amount with respect to a coordinate of a preceding vector.

12. The apparatus of claim 11, wherein storing a vector is performed when the determined perpendicular lines do not cross in a same direction.

13. The apparatus of claim 11, wherein storing a vector change amount is performed when the determined perpendicular lines cross in a same direction.

14. The apparatus of claim 13, wherein the processor further:
store a first vector from which the vector change amount is determined

15. The apparatus of claim 11, wherein the processor further:
determine whether a critical number of vectors are input.

16. The apparatus of claim 11, wherein the processor further:
store the vector and the change amount with respect to a coordinate of a preceding vector when pixels within the vectors are dense.
